(19) United States
(12) Patent Application Publication
(10) Pub. No.: US 2018/0336527 A1
(43) Pub. Date: Nov. 22, 2018

(54) OFFLINE COMPUTATION OF PARTIAL JOB RECOMMENDATION SCORES

(71) Applicant: LinkedIn Corporation, Sunnyvale, CA (US)

(72) Inventors: Krishnaram Kenthapadi, Sunnyvale, CA (US); Deepak Agarwal, Sunnyvale, CA (US)

(21) Appl. No.: 15/596,814

(22) Filed: May 16, 2017

(51) Int. Cl. G06Q 10/10; H04L 29/08; G06N 99/00

(52) U.S. Cl. CPC G06Q 10/1053; G06N 99/005; H04L 67/306

(57) ABSTRACT

A recommendation system is configured to generate relevance scores for job postings with respect to a subject member profile offline, preemptively, prior to detecting an indication that the associated subject member is logged in into the online social network system. These offline relevance scores are stored in a key-value store for future use at runtime, in response to detecting that the subject member is logged in into the online social network system. The online component of the recommendation system obtains from the key-value store the offline relevance scores, together with other features generated at runtime, and uses these scores as input when executing an online relevance model to generate respective final relevance scores for job postings that are potentially of interest to the subject member. The resulting scores are used to determine which job postings are to be recommended to the subject member.

### TECHNICAL FIELD

This application relates to the technical fields of software and/or hardware technology and, in one example embodiment, to system and method to generate, offline, partial job recommendation scores in an online social network system.

### BACKGROUND

An online social network may be viewed as a platform to connect people and share information in virtual space. An online social network may be a web-based platform, such as, e.g., a social networking web site, and may be accessed by a use via a web browser or via a mobile application provided on a mobile phone, a tablet, etc. An online social network may be a business-focused social network that is designed specifically for the business community, where registered members establish and document networks of people they know and trust professionally. Each registered member profile may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. An online social network may store include one or more components for matching member profiles with those job postings that may be of interest to the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environs within which an example method and system to generate, offline, partial job recommendation scores in an online social network system may be implemented;

FIG. 2 is block diagram of a system to generate, offline, partial job recommendation scores in an online social network system, in accordance with one example embodiment;

FIG. 3 is a flow chart illustrating a method to generate, offline, partial job recommendation scores in an online social network system, in accordance with an example embodiment; and

FIG. 4 is a diagrammatic representation of an example machine in the form of a computer system within which a set of instructions, for causing the machine to perform any one or more of the methodologies discussed herein, may be executed; and

FIG. 5 is a block diagram illustrating some elements of an offline ranker, in accordance with an example embodiment.

### DETAILED DESCRIPTION

A method and system to generate, offline, partial job recommendation scores in an online social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an online social networking application,” “an online social network system,” and “an online social network service” may be referred to as and used interchangeably with the phrase “an online social network” or merely “a social network.” It will also be noted that an online social network may be any type of an online social network, such as, e.g., a professional network, an interest-based network, or any online networking system that permits users to join as registered members. For the purposes of this description, registered members of an online social network may be referred to as simply members.

Each member of an online social network is represented by a member profile (also referred to as a profile of a member or simply a profile). A member profile may include or be associated with links that indicate the member's connection to other members of the social network. A member profile may also include or be associated with comments or recommendations from other members of the online social network, with links to other network resources, such as, e.g., publications, etc. The profile information of a social network member profile may include various information such as, e.g., the name of a member, current and previous geographic location of a member, current and previous employment information of a member, information related to education of a member, etc. The online social network system also maintains information about various companies, as well as so-called job postings. A job posting, also referred to as merely “job” for the purposes of this description, is an electronically stored entity that includes information that an employer may post with respect to a job opening.

The information in a job posting may include, e.g., industry, company, job position, required and/or desirable skills, geographic location of the job, etc. Member profiles and job postings are represented in the online social network system by feature vectors. The features in the feature vectors represent various respective characteristics of the associated job posting or member profile, such as, e.g., a job industry, a professional field, a job title, a company name, professional seniority, geographic location, etc. A characteristic of a member profile may have a corresponding characteristic in a job posting. For example, a member profile often indicates a set of skills possessed by the associated member, which is a characteristic of that member profile. On the other hand, a job posting almost always indicates a set of skills desirable for a job represented by that job posting, which is a characteristic of that job posting that corresponds to the set of skills characteristic in a member profile. A value generated for a pair comprising a member profile and a job posting that indicates the degree of similarity between a characteristic of the member profile and a corresponding characteristic of the job posting is a feature with respect to said pair. A set of features calculated with respect to a pair comprising a member profile and a job posting can be used to determine a value that represents probability of the member represented by the member profile applying for the job represented by the member profile. This value representing said probability is termed a relevance value or a relevance score.

The online social network system includes a recommendation system configured to generate job recommendations for a member as the member logs in, and cause presentation of references to one or more of the recommended jobs on the member's display device. The job postings are selected for recommendation to a particular member based on their respective relevance values generated with respect to the member profile representing that member. For example, those job postings, for which their respective relevance values for a particular member profile are equal to or greater than a predetermined threshold value, are selected for presentation to that particular member, e.g., on the news feed page of the member or on some other page provided by the online social networking system. The relevance values, in one embodiment, are generated using a statistical model (referred to as a relevance model for the purposes of this description). The online social network system utilizes multiple relevance models. For example, an offline relevance model is trained using content-based features—features generated based on the field data extracted form member profiles and job postings. A so-called online relevance model is trained using the features that are typically obtained at runtime—e.g., the fitness for a particular job of a member represented by a subject profile as compared to fitness for the same job of other members represented by their respective profiles.

A recommendation system, in some embodiments, is configured to perform some operations related to recommending jobs to a member after the member has logged in into the online social network system, and also configured to perform some of the operations related to recommending jobs to a member preemptively, prior to detecting an indication that the member logged in into the online social network system. For the purposes of this description, those operations performed with respect to a member profile during periods when the associated member is logged in into the online social network system are referred to as being performed online or at runtime. Those operations performed with respect to a member profile during periods when the associated member is not logged in into the online social network system are referred to as being performed offline. The elements of the recommendation system that perform operations offline are considered to be part of an offline ranker. The elements of the recommendation system that perform operations online are considered to be part of an online ranker. The offline ranker and the online ranker may each utilize one or more distinct relevance models.

In one embodiment, the offline ranker is configured to perform operations that are computationally expensive and/or those operations that are less time-sensitive and store the resulting values to be used, selectively, at run-time, by the online ranker. The online ranker uses the values pre-computed by the offline ranker as relevance scores for determining respective ranks of job postings and also generates respective relevance scores for any job postings that have been added subsequent to the generation of the offline values. The online ranker is also configured to discard or ignore the values pre-computed by the offline ranker with respect to a member profile if it detects changes to the member profile that occurred subsequent to the generation of the offline values.

In some embodiments, the offline ranker precomputes and stores features with respect to a pair comprising a member profile and a job posting, and then the online ranker combines these precomputed features with time-sensitive features online. Examples of features that are less time sensitive and thus could be precomputed offline are content-related features, such as features associated with sets of skills, geographic location, industry type, and seniority. An example of a feature that is more time sensitive is the relative fitness of a particular member for a particular job as compared to respective fitness for that job of the other members.

The hybrid offline/online approach to generating job recommendations for members described herein utilizes the offline and the online models as complementary: the offline model provides richer relevance of results and the online model provides freshness of results. This approach may prove to be beneficial for enabling rapid experimentation and iteration of new feature/model ideas by not requiring the feature/model computation to be implemented/performed online, enabling rich and potentially expensive features (e.g., features computed based on topic models, matrix factorization, concept graph analysis, word embeddings, etc.), beneficial for decoupling modeling efforts from infrastructure changes/limitations, prioritizing and fixing any arising issues in the recommendation system (e.g., updating the skills dictionary and skill extraction for jobs, improving term extraction using external sources, etc.), and also beneficial for guiding infrastructure decisions based on modeling results (for example, determining whether to employ neural networks or random forests).

The offline ranker includes components for collecting data that characterizes member profiles and job postings using internal and external sources. Internal sources are member profiles and job postings. External sources are the data sources that are not part of the online social network system such as, e.g., Wikipedia®. The offline ranker uses the field data extracted from the member profiles and the job postings, in some embodiments together with data obtained from external sources, to generate key concepts for members and jobs. For example, the use of external sources may reveal that the phrase “dentistry” should be treated as equivalent to the phrase “dentist” and should be represented by the same key concept (or, e.g., that that the phrase “patent attorney” should be treated as equivalent to the phrase “patent lawyer” and should be represented by the same key concept) when determining a measure of similarity between a member profile and a job posting. In one embodiment, the offline ranker generates, based on internal and external sources, a universal concept graph that includes a unified and standardized set of concept phrases. In particular, the offline ranker may utilize a linkage structure among the documents (e.g., articles) provided by an external source (e.g., hyperlinks in a given document pointing to one or more other documents) to generated key concepts. A key concept, for the purposes of this description, is a phrase that represents a characteristic of a member profile or a job posting. The offline ranker generates respective sets of key concepts for each member profile and each job posting.

The offline ranker also generates a member inverted index of key concepts where each entry is a key concept mapped to those member profiles that are associated with that key concept. The offline ranker also generates a job inverted index of key concepts where each entry is a key concept mapped to those job postings that are associated with that key concept.

The offline ranker may also be configured to generate representations of job postings and member profiles that can be used to define rich features between the fields in member profiles and the fields in job postings. For example, the offline ranker may derive features based on word embedding techniques, which is quantifying and categorizing semantic similarities between linguistic items based on their distributional properties in large samples of language data.

In some embodiments, the offline ranker generates a candidate set of pairs comprising a member profile and a job postings using the inverted indices of key concepts, such that only those pairs that have a certain number of overlapping key concepts are included in the set. The offline ranker is also configured to compute features for pairs comprising a member profile and a job postings, generate offline relevance scores for pairs comprising a member profile and a job posting using the computed features, as well as to perform training, validation, and testing of one or more offline relevance models.

In some embodiments, the offline ranker is configured to perform feature computation incrementally. For example, after the initial execution of the workflow for generating features and relevance scores for pairs comprising a member profile and a job posting, the offline ranker recalculates the features and/or the relevance scores only with respect to those member profiles that have updated with respect to those job postings that have not been previously available in the online social network system.

The online ranker detects that a member represented by a subject member profile successfully performed login operations with respect to the online social network and, in response, generates a presentation set of job postings that are then displayed to the member. In order to generate a presentation set of job postings, the online ranker executes one of the online relevance models to compute online relevance scores for candidate job postings with respect to the subject member profile and then selects the presentation set based on the respective relevance scores. The online ranker uses values generated by the offline ranker (such as relevance scores and/or features) to generate online relevance scores, as is discussed further below.

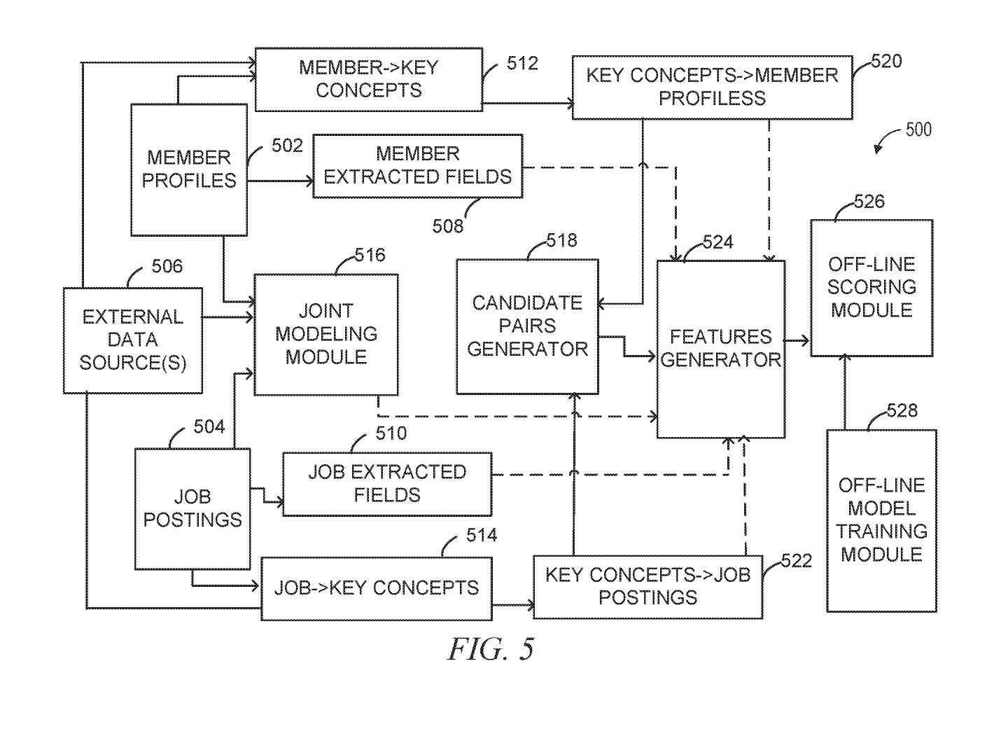

Example architecture 500 of an offline ranker, which is the offline component of the recommendation system that uses a hybrid offline/online approach for generating job recommendations for members in an online social network system, is shown in FIG. 5. The data sources 502 (member profiles), 504 (job postings), and 506 (external data sources such as, e.g., Wikipedia® eXtensible Markup Language (XML) Dump) are processed to derive key concepts. The member profiles 502 and the job postings 504 can be processed directly by extracting data from profile fields and job posting fields. Example fields of a member profile are education, experience, geographic location, industry, and skills. Job postings have fields that correspond directly or indirectly to one or more fields of member profiles. The data extracted from data from the profile fields and the job posting fields can be combined with data extracted from the external sources 506. External data may reveal additional correlation between the phrases that appear in member profiles and the job postings, as well as correlation between key concepts.

Blocks 508 and 510 are respective field data for member profiles and job postings. Blocks 512 and 514 are respective augmented field data for member profiles and job postings. Respective field data for member profiles and job postings is augmented with the key concepts derived using the external sources 506 and, optionally, with their relative importance values.

Block 516 is a joint modeling module. Starting with associations between member profiles and job postings, which can be generated based on previously monitored and collected historical data with respect to job applications and views by members, the joint modeling module 516 performs joint modeling using techniques such as, e.g., matrix factorization, topic models, and word embeddings. The joint modeling module 516 then uses the resulting representations to define rich features between member fields and job fields. The joint modeling module 516 may also be configured to represent member fields and job fields as part of a universal concept graph, and define graph-similarity-based features. The joint modeling module 516 is also configured to create mapping between member vocabulary and job vocabulary.

Blocks 520 and 522 are the member inverted index and the job inverted index described above. Block 518 is a candidate set generator. The candidate set generator 518 uses the member inverted index 520 and the job inverted index 522 to determine those job postings that can match a given member profile based on the key concept phrases that are mapped to both the subject member profile and the subject job posting. The candidate set generator 518 creates a candidate set of (member, job) pairs to be scored.

Block 524 is a features generator. The features generator 524 is configured to calculate features for (member, job) pairs, including potentially computationally expensive ⁻features derived using the representations generated using field data for member profiles and job postings (blocks 508 and 510), field data for member profiles and job postings augmented with key concepts by utilizing external sources (blocks 512 and 514), as well as representations generated by the joint modeling module 516. The features generator 524 generates features based on data from any combination of the sources 508, 510, 516, 520, and 522.

Block 526 is an offline scoring module (also referred to an offline relevance scores generator) that generates offline relevance scores for pairs comprising a member profile and a job posting, using an offline relevance model trained using an offline training module 528.

In some embodiments, the offline ranker is configured to perform feature computation incrementally. For example, after the initial execution of the workflow for generating features and relevance scores for pairs comprising a member profile and a job posting, the offline ranker recalculates the features and/or the relevance scores only with respect to those member profiles that have updated with respect to those job postings that have not been previously available in the online social network system.

The online ranker—those parts of the recommendation system that are utilized online—include a presentation set generator that ranks job postings and selects those to be presented to the subject member based on the respective ranks, and a key-value store that stores values generated offline and that is used by the presentation set generator for generating online relevance scores that are used to determine which jobs are to be presented as recommendations to the subject member. For each member profile, the key-value store stores different sets of job recommendations generated using different offline relevance models. The decision regarding the use of a certain model in production may be based on the configuration used in the A/B testing platform. During A/B testing, different subsets of member profiles could be assigned to different relevance models to identify a model that produces best results. The results of a model performance may be measured by a number of clicks on the recommended jobs and/or the number of applications resulting from the recommendations, etc. The key-value store can store, in addition to the sets of recommended jobs and their associated relevance values for member profiles, also the features generated for the respective pairs comprising a member profile and a job posting. At run time, the presentation set generator treats data stored in the key-value store as cached results and applies cache refresh operation upon detecting a change in member's profile/preferences, recent member activity, etc.

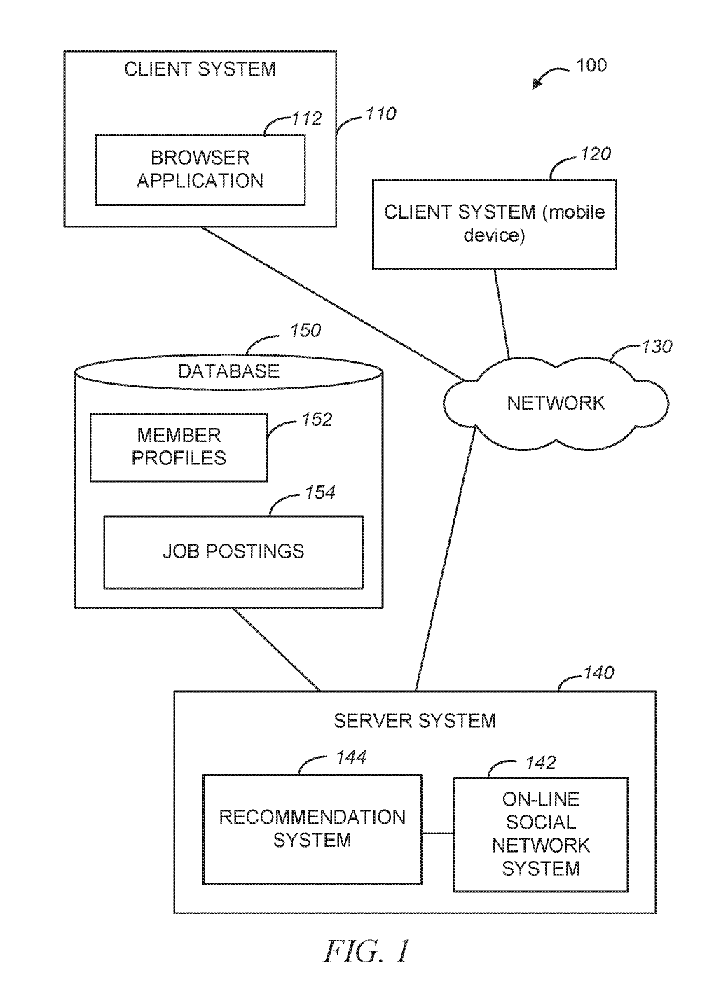

In some embodiments, the presentation set generator of the online ranker, in response to detecting that a subject member is logged in into the online social network system, obtains from the key-value store the offline relevance scores generated for the associated subject member profile and uses these scores as input when executing an online relevance model. Because the offline relevance scores are used as features, together with other features generated at runtime, when executing an online relevance model to generate respective online relevance scores for job postings with respect to the subject member profile, these scores may be referred to as partial job recommendation scores. An example recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an online social network system 142. As explained above, each member of an online social network is represented by a member profile that contains personal and professional information about the member and that may be associated with social links that indicate the member's connection to other member profiles in the online social network. Member profiles and related information may be stored in a database 150 as member profiles 152. The database 150 also stores job postings 154.

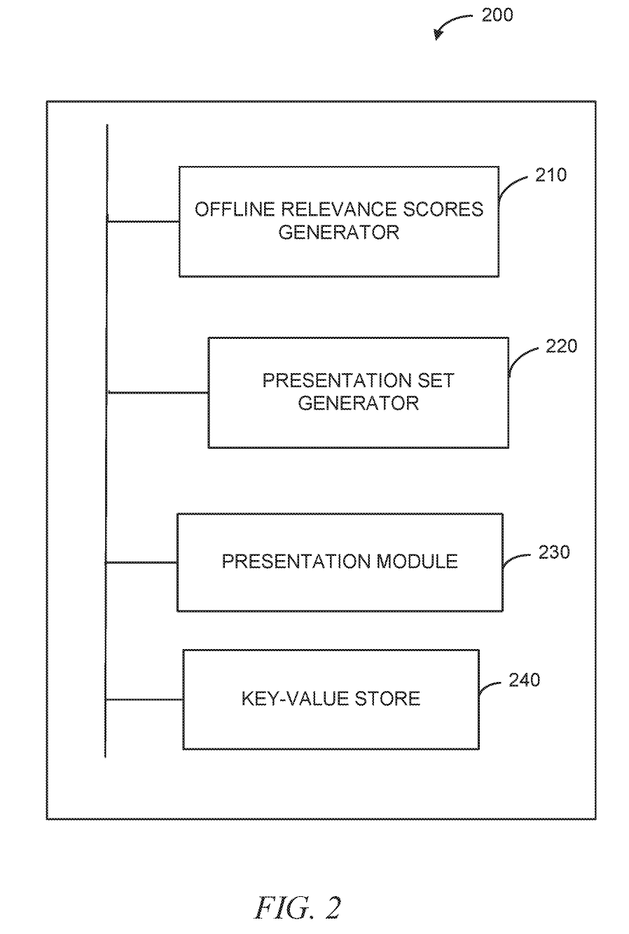

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a recommendation system 144. The recommendation system 144 is configured to generate relevance scores for job postings with respect to a subject member profile offline, preemptively, prior to detecting an indication that the associated subject member is logged in into the online social network system 142. These offline relevance scores are stored in a key-value store provided with the recommendation system 144 for future use at runtime, in response to detecting that the subject member is logged in into the online social network system 142. The online component of the recommendation system 144 obtains from the key-value store the offline relevance scores, together with other features generated at runtime, and uses these scores as input when executing an online relevance model provided with the recommendation system 142 to generate respective runtime relevance scores for job postings that are potentially of interest to the subject member. The resulting scores are used to determine which job postings are to be recommended to the subject member. An example of an online social network system is LinkedIn®. An example recommendation system, which corresponds to the recommendation system 144 is illustrated in FIG. 2.

FIG. 2 is a block diagram of a system 200 to generate, offline, partial job recommendation scores in the online social network system 142 of FIG. 1. As shown in FIG. 2, the system 200 includes an offline relevance scores generator 210, a presentation set generator 220, and a presentation module 230.

The offline relevance scores generator 210 is configured to generate offline relevance scores for candidate job postings provided in the online social network system 142 of FIG. 1 with respect to a subject member profile maintained in the online social network system. As explained above, a relevance score generated with respect to the subject member profile and a certain job posting from the candidate job postings reflects probability of a member represented by the subject member profile applying for a job represented by the certain job posting. In order to generate the offline relevance scores, the offline relevance scores generator 210 executes an offline relevance model, which is trained using training data collected with respect to members interacting with job postings in the online social network system and also using content-based features generated with respect to field data obtained from member profiles and job postings.

The presentation set generator 220 is configured to generate a set of job postings to be recommended to a subject member in response to detecting that the subject member represented by the subject member profile is logged in into the online social network system 142. The presentation set generator 220 generates online features with respect to the subject member profile and respective job postings, executes an online relevance model using the online features together with the offline relevance scores as input into the online relevance model in order to generate respective runtime relevance scores for the respective job postings, and selects a presentation set of job postings based on the respective online relevance values generated for each job posting from the respective job postings. The online relevance model is trained using the online features—those features that are more time sensitive than, e.g., field data of member profiles and job postings). In some embodiments, the online relevance model executed by the presentation set generator 220 utilizes an approach that is different from an approach utilized by the offline relevance model executed by the offline relevance scores generator 210.

The presentation set generator generates the offline relevance scores using features that are, in turn, generated utilizing field data extracted from the subject member profile and the candidate job postings. The presentation set generator 220 generates online features, such as, e.g., a relative fitness value for the subject member profile. The relative fitness value indicates a likelihood that the subject member is hired for a job represented by a particular job posting in relationship to a likelihood that another member represented by another member profile is hired for that particular job. Another example of an online feature generated by the presentation set generator 220 is a feature reflecting the number of presentation sets generated for members other than the subject member that include a particular job posting. In order to generate said feature, the presentation set generator 220 utilizes a cap value that limits a number of member profiles for which the particular job can be recommended.

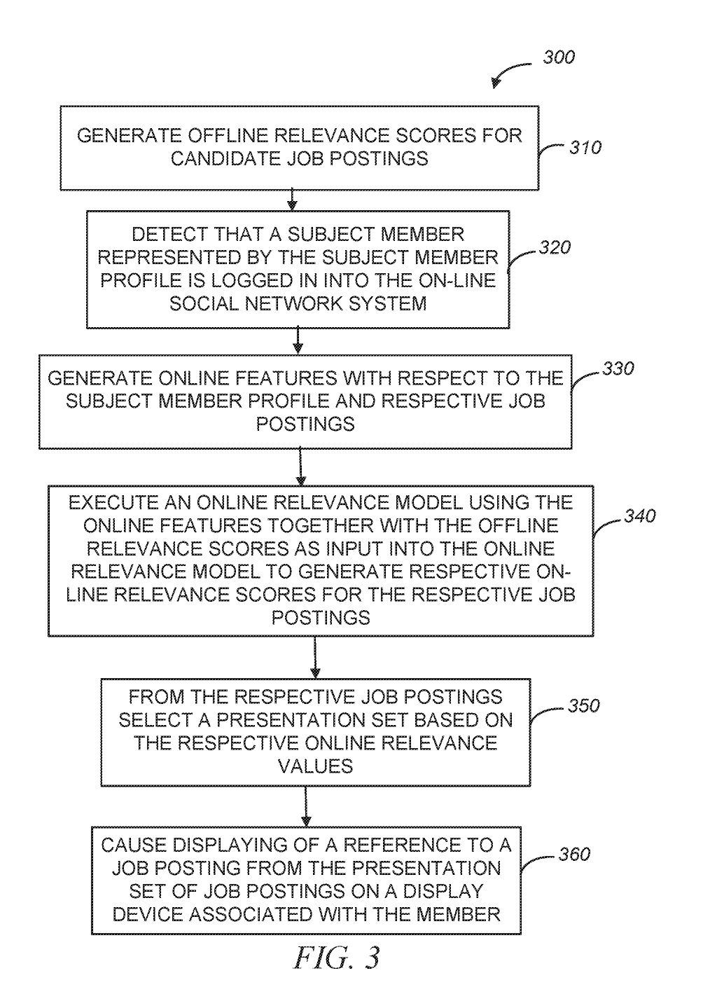

The presentation module 230 is configured to cause presentation, on a display device, of references to job postings included in the presentation set of job recommendations. Also shown in FIG. 2 is a key-value store 240 accessible to the presentation set generator 220. The key-value store 240 stores offline relevance values generated by the offline relevance scores generator 210. Some operations performed by the system 200 may be described with reference to FIG. 3.

FIG. 3 is a flow chart of a method 300 to generate, offline, partial job recommendation scores in the online social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the offline relevance scores generator 210 of FIG. 2 generates offline relevance scores for candidate job postings provided in the online social network system 142 of FIG. 1 with respect to a subject member profile maintained in the online social network system. At operation 320, the presentation set generator 220 of FIG. 2 detects that the subject member represented by the subject member profile is logged in into the online social network system 142. The presentation set generator 220 generates online features with respect to the subject member profile and respective job postings at operation 330, executes an online relevance model using the online features together with the offline relevance scores as input into the online relevance model in order to generate respective runtime relevance scores for the respective job postings at operation 340, and selects a presentation set of job postings based on the respective online relevance values generated for each job posting from the respective job postings at operation 350.

The presentation module 230 of FIG. 2 causes presentation, on a display device, of references to job postings included in the presentation set of job recommendations, at operation 360.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

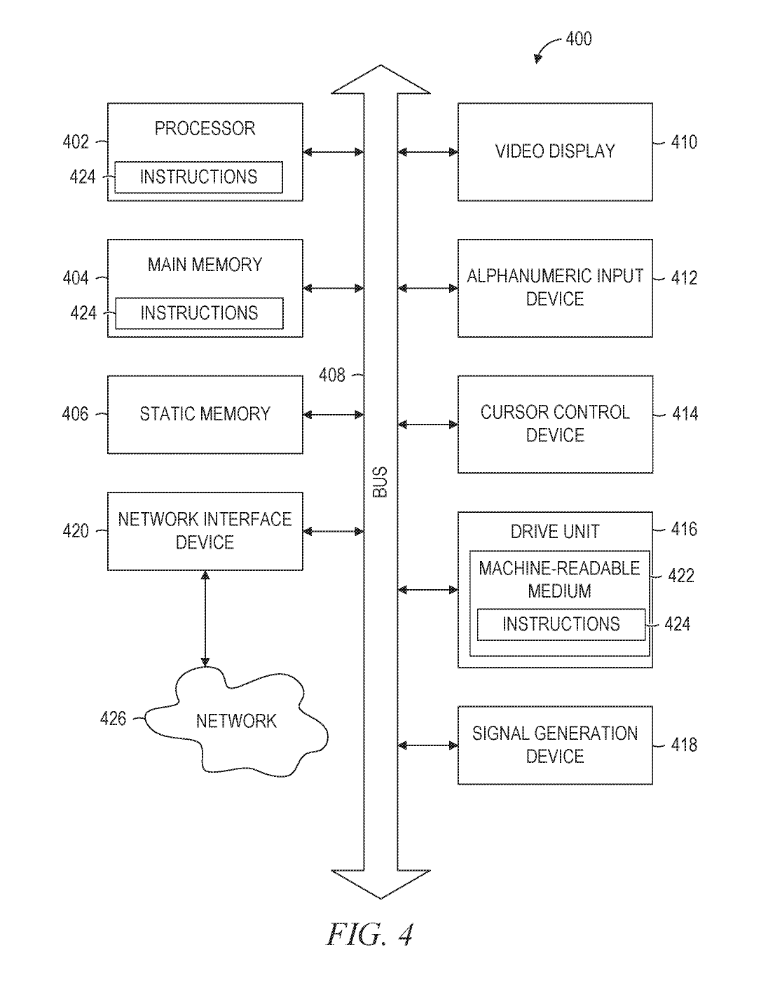

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media.

Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may he configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program interfaces (APIs).)

Thus, a method and system to generate, offline, partial job recommendation scores in an online social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
generating and storing for future use offline relevance scores for candidate job postings provided in an online social network system with respect to a subject member profile maintained in the online social network system, a relevance score generated with respect to the subject member profile and a certain job posting from the candidate job postings reflecting probability of a member represented by the subject member profile applying for a job represented by the certain job posting;
in response to detecting that a subject member represented by the subject member profile is logged in into the online social network system, using at least one processor:
generating online features with respect to the subject member profile and respective job postings, the respective job postings comprising one or more postings from the candidate job postings,
executing an online relevance model using the online features together with the offline relevance scores as input into the online relevance model to generate respective runtime relevance scores for the respective job postings, and
from the respective job postings selecting a presentation set based on the respective online relevance values generated for each job posting from the respective job postings; and
causing displaying of a reference to a job posting from the presentation set on a display device associated with the subject member.

2. The method of claim 1, wherein the generating of the offline relevance scores comprises utilizing field data extracted from the subject member profile and the candidate job postings.

3. The method of claim 1, wherein the generating of the online features comprises generating a relative fitness value, the relative fitness value indicating a likelihood that the subject member is hired for a job represented by a particular job posting from the candidate set of job postings in relationship to a likelihood that another member represented by another profile from the candidate set of member profiles is hired for the particular job.

4. The method of claim 3, wherein the generating of the online features comprises utilizing a cap value that limits a number of member profiles for which the particular job can be recommended.

5. The method of claim 4, comprising utilizing a number of further member profiles, for which the particular job has been recommended.

6. The method of claim 1, wherein the generating of the offline relevance scores comprises executing an offline relevance model.

7. The method of claim 6, wherein the online relevance model utilizes an approach that is different from an approach utilized by the offline relevance model.

8. The method of claim 6, comprising training the offline relevance model using training data collected with respect to members interacting with job postings in the online social network system;

9. The method of claim 1, comprising training the online relevance model using the online features.

10. The method of claim 1, comprising training the offline relevance model using content-based features.

11. A computer-implemented system comprising:
an offline relevance scores generator, implemented using at least one processor, to generate offline relevance scores for candidate job postings provided in an online social network system with respect to a subject member profile maintained in the online social network system, a relevance score generated with respect to the subject member profile and a certain job posting from the candidate job postings reflecting probability of a member represented by the subject member profile applying for a job represented by the certain job posting;
a presentation set generator, implemented using at least one processor, in response to detecting that a subject member represented by the subject member profile is logged in into the online social network system, to:
generate online features with respect to the subject member profile and respective job postings, the respective job postings comprising one or more postings from the candidate job postings,
execute an online relevance model using the online features together with the offline relevance scores as input into the online relevance model to generate respective runtime relevance scores for the respective job postings, and
from the respective job postings select a presentation set based on the respective online relevance values generated for each job posting from the respective job postings; and
a presentation module, implemented using at least one processor, to cause displaying of a reference to a job posting from the presentation set on a display device associated with the subject member.

12. The system of claim 11, wherein the presentation set generator generates the offline relevance scores utilizing field data extracted from the subject member profile and the candidate job postings.

13. The system of claim 11, wherein the presentation set generator is to generate a relative fitness value, the relative fitness value indicating a likelihood that the subject member is hired for a job represented by a particular job posting from the candidate set of job postings in relationship to a likelihood that another member represented by another profile from the candidate set of member profiles is hired for the particular job, the relative fitness value is a feature from the online features.

14. The system of claim 13, wherein the presentation set generator is to generate a feature from the online features utilizing a cap value that limits a number of member profiles for which the particular job can be recommended.

15. The system of claim 14, wherein the presentation set generator is to generate a feature from the online features a number of further member profiles, for which the particular job has been recommended.

16. The system of claim 11, wherein the offline relevance scores generator executes an offline relevance model to generate the offline relevance scores comprises.

17. The system of claim 16, wherein the online relevance model utilizes an approach that is different from an approach utilized by the offline relevance model.

18. The system of claim 16, wherein the offline relevance model is trained using training data collected with respect to members interacting with job postings in an online social network system.

19. The system of claim 11, wherein the online relevance model is trained using the online features.

20. A machine-readable non-transitory storage medium having instruction data executable by a machine to cause the machine to perform operations comprising:
generating and storing for future use offline relevance scores for candidate job postings provided in an online social network system with respect to a subject member profile maintained in the online social network system, a relevance score generated with respect to the subject member profile and a certain job posting from the candidate job postings reflecting probability of a member represented by the subject member profile applying for a job represented by the certain job posting;
in response to detecting that a subject member represented by the subject member profile is logged in into the online social network system:
generating online features with respect to the subject member profile and respective job postings, the respective job postings comprising one or more postings from the candidate job postings,
executing an online relevance model using the online features together with the offline relevance scores as input into the online relevance model to generate respective runtime relevance scores for the respective job postings, and
from the respective job postings selecting a presentation set based on the respective online relevance values generated for each job posting from the respective job postings; and
causing displaying of a reference to a job posting from the presentation set on a display device associated with the subject member.
